(19) United States
(12) Patent Application Publication
(10) Pub. No.: US 2009/0253830 A1
(43) Pub. Date: Oct. 8, 2009

(54) METHOD FOR ADDING ANTI-FOAMING AGENT INTO CATIONIC ELECTRODEPOSITION PAINT AND ADDITIVE USED IN THE SAME

(76) Inventor: Koji Izumiya, Osaka (JP)

Correspondence Address: WENDEROTH, LIND & PONACK, L.L.P., 1030 15th Street, N.W.,, Suite 400 East, Washington, DC, 20005-1503, US

(21) Appl. No.: 12/309,830

(22) PCT Filed: Jul. 30, 2007
(86) PCT No.: PCT/JP2007/064871

§ 371 Date: May 15, 2009

(30) Foreign Application Priority Data
Aug. 1, 2006 (JP) 2006-209948

(51) Int. Cl. C09D 5/44

(52) U.S. Cl. 523/456; 523/400

(57) ABSTRACT

A method for stably and effectively adding a hydrophobic anti-foaming agent into the electrodeposition paint is achieved by adding an anti-foaming agent into a cationic electrodeposition paint wherein, when adding the anti-foaming agent to a cationic electrodeposition paint, a dispersion obtained by preliminarily dispersing the anti-foaming agent into a pigment dispersing resin for a cation electrodeposition paint in an amount of 5 to 1,000 parts by weight (solid content) based on 100 parts by weight (solid content) of a pigment dispersing resin is added to the cationic electrodeposition paint.

### FIELD OF THE INVENTION

The present invention relates to a method for adding an anti-foaming agent into cationic electrodeposition paint and an anti-foaming additive used for the method.

### PRIOR ART

Electrodeposition coating is an immersion coating, and an article to be coated is immersed in a paint solution and coated by applying electric current. When the article is entered into and/or taken out of an electrodeposition paint vessel, the article often generates foams in the paint vessel. When foams are left alone, the foams are coagulated to cause surface defects, such as aggregates. In addition, since the article is coated in a state of containing the foams, the generation of the traces of the foams on a coating film leads to a defective condition that the sites are not coated. Consequently, it is generally carried out to use various anti-foaming agents in the electrodeposition paint.

Many anti-foaming agents expressing effect not only in the electrodeposition paint but also in an aqueous paint are hydrophobic. Hydrophobic properties are necessary for forming insoluble oil portion on the surface of a foam film and thereby, surface tension in the foam film is inhomogeneous. As a result, the foam film is unstable to be broken. Since the anti-foaming agent shows hydrophobic properties, the anti-foaming agent is strongly stirred to be dispersed by applying shear when the anti-foaming agent is formulated into an aqueous paint. In the electrodeposition paint, the anti-foaming agent is formulated during an emulsifying process of resin for electrodeposition paint. However, depending on the characteristics of a coating plant, formulating the anti-foaming agent after forming paint or in a paint bath under operating, so-called “post-addition” can also be requested.

However, when the anti-foaming agent is post-added in an electrodeposition paint which has a very low viscosity and is not expected to apply high shear, the anti-foaming agent is not uniformly mixed in the paint solution and inhomogeneously exists in the form of a large oil drop in the paint. As a result, the anti-foaming agent may not adequately exhibit its function originally possessed, but also there are cases that the anti-foaming agent in the oil drop forms inhomogeneously adheres on the coating film, the uniformity of the surface tension of an uncured coating surface is damaged and coating film defects, such as craters, may be seriously generated.

As its countermeasure, when the anti-foaming agent is post-added to an electrodeposition paint, the anti-foaming agent is solved in an organic solvent and then added into the electrodeposition paint. However, the dispersion of the anti-foaming agent is often inadequate and has no immediate effect even by the method. Further, depending on kinds of an organic solvent for dissolving the anti-foaming agent, the solvent coagulates the paint to be destabilized and a defect, such as aggregates, is occasionally generated.

Several patent applications exist for the anti-foaming agent added into the cationic electrodeposition paint, but all of them are studied from the composition of the anti-foaming agent and it is status quo that a method for adding the anti-foaming agent has been hardly studied in the existing circumstances.

For example, Japanese Kokai Patent Publication No. 2004-339364 shows that anti-foaming properties and water dispersibility are improved by using a surfactant containing a specific polyalkylene compound as an anti-foaming agent. Further, Japanese Kokai Patent Publication No. 2002-126404 shows an anti-foaming agent composition which contains a compound (A) of sucrose with alkylene oxide and a compound (B) of monoalcohol with alkylene oxide and shows that the composition exhibits superior anti-foaming properties and rinsing property. Further, Japanese Kokai Patent Publication No. 2002-60682 and Japanese Kokai Patent Publication No. 2002-58905 and the like disclose techniques studying the composition of an anti-foaming properties. However, either of the techniques studied the composition of the anti-foaming agent itself and did not study a method for adding an anti-foaming agent.

### OBJECT OF THE INVENTION

An object of the present invention is to stably add a hydrophobic anti-foaming agent to the electrodeposition paint.

### SUMMARY OF THE INVENTION

Namely, the present invention provides a method for adding an anti-foaming agent into a cationic electrodeposition paint, wherein, when adding the anti-foaming agent to a cationic electrodeposition paint, a dispersion obtained by preliminarily dispersing the anti-foaming agent into a pigment dispersing resin for a cation electrodeposition paint in an amount of 5 to 1,000 parts by weight (solid content) based on 100 parts by weight (solid content) of a pigment dispersing resin is added to the cationic electrodeposition paint.

In the present invention, the cationic electrodeposition paint contains a cationic epoxy resin, a curing agent and a pigment, and the pigment is mixed in a form of pigment paste in which the pigment is preliminarily dispersed with the pigment dispersing resin for the cationic electrodeposition paint.

In the present invention, an additive for anti-foaming is prepared by mixing the anti-foaming agent with the pigment dispersing resin for the cationic electrodeposition paint and then mixed in the cationic electrodeposition paint.

The anti-foaming agent of the present invention is preferably a nonionic anti-foaming agent or an acetylene diol anti-foaming agent.

The present invention also provides an anti-foaming additive of cationic electrodeposition paint containing the anti-foaming agent and the pigment dispersing resin for the cationic electrodeposition paint.

The above-mentioned anti-foaming agent is preferably dispersed preliminarily in the pigment dispersing resin for the cationic electrodeposition paint.

The present invention also provides a method of increasing the foaming properties of an anti-foaming agent wherein, when adding the anti-foaming agent to a cationic electrodeposition paint, the anti-foaming agent is preliminarily dispersed in a pigment dispersing resin for a cation electrodeposition paint in an amount of 5 to 1,000 parts by weight (solid content) based on 100 parts by weight (solid content) of the pigment dispersing resin and then added to the cationic electrodeposition paint.

In addition, the present invention provides a method for preventing bad influence by an anti-foaming agent in a cationic electrodeposition paint, wherein, when adding the anti-foaming agent to a cationic electrodeposition paint, the anti-foaming agent is preliminarily dispersed in a pigment dispersing resin used for the dispersion of the pigment of the cationic electrodeposition paint, in an amount of 5 to 1,000 parts by weight (solid content) based on 100 parts by weight (solid content) of the pigment dispersing resin.

According to the present invention, the anti-foaming agent is not added to a cationic epoxy resin being a main resin and is not added to the cationic electrodeposition paint as a mixture with a solvent, but is added to the cationic electrodeposition paint together with the pigment dispersing resin in a mixed state. According to the method, anti-foaming effects after adding the anti-foaming agent are immediately effective and are not damaged. Further, it has also advantages that there is no coating film defect such as craters and the aggregate of the paint at addition hardly occurs.

### DETAILED DESCRIPTION OF THE INVENTION

The present invention is more specifically illustrated below. In general, cationic electrodeposition paint contains a cationic epoxy resin (in particular, amine-modified epoxy resin) and the curing agent of the resin (in particular, blocked isocyanate curing agent) as basic components and contains other pigment and additives, which are dispersed in an aqueous medium. The pigment is generally added to the cationic electrodeposition paint in the form of pigment paste that pigment is kneaded with a resin so-called a pigment dispersing resin.

In the present invention, the anti-foaming agent is added to the cationic electrodeposition paint in combination with the pigment dispersing resin for cationic electrodeposition paint (in the present specification, it is merely called as the “pigment dispersing resin” occasionally). The addition can be when formulating the electrodeposition paint, or can be also so-called “post-addition” by which addition is carried out after forming the electrodeposition paint. In addition, it may be added by post-addition in an electrodeposition paint bath in which coating is being operated. In the present invention, high anti-foaming effect can be expected in the post-addition in particular. The anti-foaming agent and the pigment dispersing resin are usually used as additives in which the anti-foaming agent and the pigment are dispersed using a dispersion machine such as a disper.

Anti-Foaming Agent

The anti-foaming agent used in the present invention may be not limited so far as it is used as the anti-foaming agent of the cationic electrodeposition paint, but those belonging to a hydrophobic anti-foaming agent are preferable. Examples of the anti-foaming agent include an animal and plant oil type anti-foaming agent, a fatty acid type anti-foaming agent, a nonionic type anti-foaming agent (in particular, a polyether anti-foaming agent), an acetylene diol type anti-foaming agent, a fluorine type anti-foaming agent, a silicone type anti-foaming agent, a mineral oil type anti-foaming agent, a phosphoric acid ester type anti-foaming agent and the like, but an animal and plant oil type anti-foaming agent, a fatty acid type anti-foaming agent, a nonionic type anti-foaming agent (in particular, a polyether type anti-foaming agent) and an acetylene diol type anti-foaming agent are preferable. A nonionic type anti-foaming agent (in particular, a polyether type anti-foaming agent) and an acetylene diol type anti-foaming agent are more preferable. In particular, an acetylene diol type anti-foaming agent (Surfynol 124 manufactured by Air Products and Chemicals, Inc.).

An amount of the anti-foaming agent is not specifically limited, but is 5 to 1,000 parts by weight (solid content) of the anti-foaming agent based on 100 parts by weight (solid content) of the pigment dispersing resin, preferably 5 to 500 parts by weight and more preferably 20 to 200 parts by weight. When it is less than 5 parts by weight, anti-foaming properties are not adequate. When it exceeds 1,000 parts by weight, dispersibility of the anti-foaming agent is bad and unstable in “the anti-foaming agent dispersed with the pigment dispersing resin”.

The anti-foaming agent is used by admixing with the pigment dispersing resin, as described above. The pigment dispersing resin is described in detail in the illustration of the under-mentioned cationic electrodeposition paint composition.

Cationic Electrodeposition Paint Composition

In an electrodeposition coating method of the present invention, any cationic electrodeposition paint composition that has generally been used can be used. The cationic electrodeposition paint composition includes a cationic epoxy resin, and a curing agent, as well as a pigment and additives if necessary. Respective components are illustrated below.

Cationic Epoxy Resin

The cationic epoxy resin used in the present invention includes an epoxy resin modified with amine. The cationic epoxy resin is typically produced by ring-opening all of the epoxy rings in a bis-phenol type epoxy resin with an active hydrogen compound capable of introducing a cationic group, or by ring-opening a portion of the epoxy rings with another active hydrogen compound and ring-opening the residue of the epoxy rings with the active hydrogen compound capable of introducing a cationic group.

Typical examples of the bis-phenol type epoxy resin include a bis-phenol A type epoxy resin or a bis-phenol F type epoxy resin. The bis-phenol type epoxy resin are commercially available as EPICOAT 828 (manufactured by Japan Epoxy Resins Co., Ltd., and an epoxy equivalent weight of 180 to 190), EPICOAT 1001 (the same and an epoxy equivalent weight of 450 to 500), EPICOAT 1010 (the same and an epoxy equivalent weight of 3,000 to 4,000) and the like and the bis-phenol F type epoxy resin are commercially available as EPICOAT 807 (the same and an epoxy equivalent of 170) and the like.

As the cationic epoxy resin, there may be also used an oxazolidone ring-containing epoxy resin which is indicated by the following chemical formula:

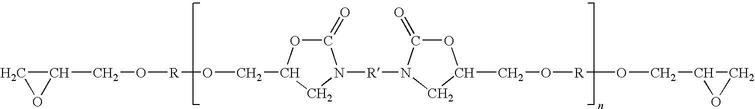

wherein, R represents a residual group excluding a glycidyloxy group of a diglycidyl epoxy compound, R′ represents a residual group excluding the isocyanate group of a diisocyanate compound and n represents a positive integer, that is described in Japanese Kokai Patent Publication No. 5-306327.

As a method of introducing an oxazolidone ring in an epoxy resin, for example, a blocked polyisocyanate in which an isocyanate group is blocked with a lower alcohol such as methanol and polyepoxide is heated in the presence of a basic catalyst to keep the temperature and the lower alcohol prepared as a by-product is distilled from the system to be obtained.

Epoxy resin is preferably an oxazolidone ring-containing epoxy resin. It is because a coating film superior in heat resistance and corrosion resistance and also further superior in impact resistance is obtained.

It is publicly known that the oxazolidone ring-containing epoxy resin is obtained by reacting a bifunctional epoxy resin with diisocyanate blocked with monoalcohol (namely, bisurethane). Specific examples and a production process of the oxazolidone ring-containing epoxy resin are described in, for example, Japanese Kokai Patent Publication No. 2000-128959, columns 0012^{th} to 0047^{th} and publicly known.

These epoxy resins may also be modified with appropriate resins such as polyester polyol, polyether polyol and monofunctional alkyl phenol. Further, the epoxy resin can elongate its chain utilizing the reaction of an epoxy group and diol or dicarboxylic acid.

It is desirable that the rings of the epoxy resins are opened with an active hydrogen compound so as to be an amine equivalent of 0.3 to 4.0 meq/g after the ring-opening and more preferably so that primary amino groups occupy 5 to 50% among them.

Examples of the active hydrogen compound capable of introducing a cationic group include primary amine, secondary amine and acid salts of tertiary amine and sulfide and its acid mixture. The primary amine, secondary amine and acid salts of tertiary amine are used as the active hydrogen compound capable of introducing a cationic group in order to prepare an epoxy resin containing the primary amine, secondary amine or/and tertiary amine.

Specific examples include butylamine, octylamine, diethylamine, dibutylamine, methylbutylamine, monoethanolamine, diethanolamine, N-methylethanolamine, triethylamine hydrochloride, N,N-dimethylethanolamine acetate, a mixture of diethylsulfide and acetic acid and the like, and additionally, secondary amines blocking primary amine such as the ketimine of aminoethylethanolamine and the diketimine of diethylenetriamine. A plurality of amines may be used in combination.

Curing Agent

The curing agent used in the present invention is preferably a blocked polyisocyanate that is obtained by reacting the polyisocyanate with a blocking agent. In this context, the polyisocyanate represents a compound having 2 or more of isocyanate groups in a molecule. Examples of the polyisocyanate may be any one among an aliphatic base, an alicyclic base, an aromatic base and aromatic-aliphatic base, etc.

Specific examples of the polyisocyanate include aromatic diisocyanates such as tolylene diisocyanate (TDI), diphenylmethane diisocyanate (MDI), p-phenylene diisocyanate and naphthalene diisocyanate; aliphatic diisocyanates having 3 to 12 carbon atoms such as hexamethylene diisocyanate (HDI), 2,2,4-trimethylhexane diisocyanate and lysine diisocyanate; alicyclic diisocyanates having 5 to 18 carbon atoms such as 1,4-cyclohexane diisocyanate (CDI), isophorone diisocyanate (IPDI), 4,4′-dicyclohexylmethane diisocyanate (hydrogenated MDI), methylcyclohexane diisocyanate, isopropylidene dicyclohexyl-4,4′-diisocyanate and 1,3-diisocyanatomethylcyclohexane (hydrogenated XDI), hydrogenated TDI and 2,5- or 2,6-bis(isocyanatomethyl)-bicyclo[2,2,1]heptane (also called as norbornane diisocyanate); aliphatic diisocyanates having an aromatic ring such as xylylene diisocyanate (XDI) and tetramethylxylylene diisocyanate (TMXDI); and modified products of these diisocyanates (urethanated product, carbodiimides, urethodion, urethoimine, biuret and/or an isocyanurate modified product). These can be used alone or in combination of two or more thereof.

An adduct or a prepolymer obtained by reacting the polyisocyanate with polyvalent alcohols such as ethylene glycol, propylene glycol, trimethylol propane and hexanetriol at an NCO/OH ratio of 2 or more may be also used as the curing agent.

The polyisocyanate is preferably an aliphatic polyisocyanate or an alicyclic polyisocyanate. It is because the coating film formed is superior in weather resistance.

Preferable specific examples of the aliphatic polyisocyanate or alicyclic polyisocyanate include hexamethylene diisocyanate, hydrogenated TDI, hydrogenated MDI, hydrogenated XDI, IPDI, norbornane diisocyanate, a dimer thereof (biuret), a trimer thereof (isocyanurate), and the like.

The block agent is added with a polyisocyanate group and stable at ambient temperature but can regenerate a free isocyanate group when it is heated to dissociation temperature or more.

When curing at low temperature (160° C. or less) is desired, lactam block agents such as ε-caprolactam, δ-valerolactam, γ-butyrolactam and β-propiolactam and oxime block agents such as formaldoxime, acetaldoxime, acetoxime, methyl ethyl ketoxime, diacetyl monooxime and cyclohexane oxime had better to be used as the block agent.

The electrodeposition paint composition contains generally a binder containing the cationic epoxy resin and the curing agent in an amount of 25 to 85% by mass based on the total solid content of the electrodeposition paint composition and preferably 40 to 70% by mass.

Pigment

The electrodeposition paint composition used for the present invention may contain pigments that have been usually used. Examples of the pigment include inorganic pigments usually used, for example, such as coloring pigments such as titanium white, carbon black and red oxide; filler pigments such as kaolin, talc, aluminum silicate, calcium carbonate, mica and clay; anti-corrosive pigments such as zinc phosphate, ferric phosphate, aluminum phosphate, calcium phosphate, zinc phosphite, zinc cyanide, zinc oxide, aluminum tripolyphosphate, zinc molybdate, aluminum molybdate, calcium molybdate, aluminum phosphomolybdate and zinc phosphomolybdate.

The pigment is generally contained in the electrodeposition paint composition in an amount of 1 to 35% by mass based on all of the solid content of the electrodeposition paint composition and preferably 10 to 30% by mass.

Pigment Dispersing Paste

When a pigment is used as the component of the electrodeposition paint, the pigment is preliminarily dispersed at high concentration in an aqueous medium together with a resin called as a pigment dispersing resin, to prepare paste. Since the pigment is powdery shape, it is difficult to disperse the pigment at one step in a uniform state with low concentration used for the electrodeposition paint composition. In general, the paste is called as pigment dispersing paste.

The pigment dispersing paste is prepared by dispersing the pigment together with pigment dispersing resin varnish in the aqueous medium. As the pigment dispersing resin varnish, a cationic or nonionic low molecular weight surfactant and a cationic polymer such as a modified epoxy resin having a quaternary ammonium group and/or a tertiary sulfonium group are used. As the aqueous medium, ion exchanged water, water containing a small amount of alcohols, and the like are used. In general, the pigment dispersing resin varnish is used at a solid content ratio of 5 to 40 parts by mass and the pigment is at that of 10 to 30 parts by mass.

After the above-mentioned pigment dispersing resin varnish and pigment are mixed at 10 to 1,000 parts by mass per 100 parts by mass of the resin solid content, the mixture is dispersed using a usual dispersing machine such as a ball mill or a sand grind mill until the particle diameter of the pigment in the mixture is a fixed uniform particle diameter, to obtain the pigment dispersing paste.

In the present invention, it is a point greatly different from a conventional technique that the above-mentioned pigment dispersing resin is used not only for the dispersion of the pigment, but also used for the mixing and dispersion of the anti-foaming agent. As described above, the dispersion is carried out by dispersing and mixing the pigment dispersing resin and the anti-foaming agent by a dispersing machine such as a disper.

The mixture additive of the anti-foaming agent with the pigment dispersing resin may be compounded at preparation of the cationic electrodeposition paint composition described later. Further, it may be added as an additive to the cationic electrodeposition paint composition preliminarily prepared. Further, after it is added as the additive of the anti-foaming agent in a cationic electrodeposition paint bath in which electrodeposition coating is carried out, mixing is slightly carried out and then it may be also homogeneously mixed in the paint bath.

Preparation of Electrodeposition Paint Composition

The electrodeposition paint composition is prepared by dispersing a cationic epoxy resin, a curing agent and the pigment dispersing paste in aqueous medium. Further, a neutralizing agent is usually contained in the aqueous medium in order to improve the dispersibility of the cationic epoxy resin. The neutralizing agent is inorganic acid or organic acid such as hydrochloric acid, nitric acid, phosphoric acid, formic acid, acetic acid or lactic acid. Its amount is amount attaining a neutralization rate of at least 20% and preferably 30 to 60%.

The amount of the curing agent must be amount enough for reacting it with an active hydrogen-containing functional group such as a primary amino group, a secondary amino group or/and a tertiary amino group in the cationic epoxy resin or a hydroxyl group at curing, and is generally a range of 90/10 to 50/50 and preferably 80/20 to 65/35 that is represented by solid mass ratio to the curing agent of the cationic epoxy resin.

The electrodeposition paint can contain tin compounds such as dibutyltin dilaurylate and dibutyltin oxide and a usual urethane cleavage catalyst. Since those not substantially containing lead are preferable, it is preferable that its amount is 0.1 to 5% by mass based on the blocked polyisocyanate compound

The electrodeposition paint composition can contain water-miscible organic solvent and usual additives such as a surfactant, an ultraviolet absorbent and a pigment. The anti-foaming agent is also included in the additives.

The pH buffer of the present invention may be directly added to the electrodeposition paint composition but may be introduced in the electrodeposition paint composition in a form of a pre-mixture with the resin and pigment paste.

It is preferable that a coated article in case of carrying out electrodeposition coating using the electrodeposition paint composition is an electric conductor on which surface treatment such as zinc phosphate treatment is preliminarily carried out by immersion, spray methods and the like, but those on which the surface treatment is not carried out may be used as well. Further, the electric conductor is not specifically limited so far as it can be a cathode electrode at carrying out electrodeposition coating, and a metal substrate is preferable.

The condition carrying out the electrodeposition is similar as those generally used for other type electrodeposition coating. The applied voltage may be largely changed and may be a range of 1 volt to several hundred volts. The current density is usually about 10 A/m² to 160 A/m² and tends to be decreased during the electrodeposition.

After the electrodeposition coating is carried out by the electrodeposition coating method of the present invention, the coated article is baked at an elevated temperature by a conventional method, for example, in a calcinations oven or by an infrared heating lamp. Although the baking temperature may be changed, it is usually about 140° C. to 180° C. The coated article is finally rinsed with water and dried and baked to obtain a cured electrodeposition coating film.

### EXAMPLES

The present invention is more specifically illustrated according to Examples. The present invention should not be construed as being limited to Examples.

### Production Example 1

### Production of Pigment Dispersing Resin Varnish Having Sulfonium Group

Into a reactor equipped with a stirrer, a condenser, a nitrogen introduction tube and a thermometer, 222.0 parts of isophorone diisocyanate (hereinafter, called as IPDI) was charged and diluted with 39.1 parts of methyl isobutyl ketone (hereinafter, called as MIBK) and then, 0.2 part of dibutyltin laurate was added. Then, after temperature was raised to 50° C., 131.5 parts of 2-ethylhexanol was added dropwise in a dry nitrogen atmosphere over 2 hours while stirring. The reaction temperature was kept at 50° C. by appropriate cooling. As a result, IPDI half-blocked with 2-ethylhexanol was obtained.

Then, into an appropriate reactor, 382.2 parts of a bisphenol A epoxy resin (manufactured by Dow Chemical Company) with an epoxy equivalent of 188 and 117.8 parts of bisphenol A were charged and heated to 150 to 160° C. under a nitrogen atmosphere. The reaction mixture was reacted at 150 to 160° C. for about 1 hour and then cooled to 120° C. After that time, 209.8 parts of the IPDI half-blocked with 2-ethylhexanol that was prepared in the above-described process was added. The mixture was reacted at 140 to 150° C. for 1 hour, 205 parts of a polyalkylene oxide compound (trade name: BPE-60 manufactured by Sanyo Kasei Co., Ltd. R represents an ethylene group and m+n represents about 6.) was added and then the mixture was cooled to 60 to 65° C. To the content, 408.0 parts of 1-(2-hydroxyethylthio)-2-propanol, 144.0 parts of deionized water and 134 parts of dimethylol propionate were added, and reacted at 65 to 75° C. until an acid value was 1, to introduce a tertiary-sulfonium into the epoxy resin. Pigment dispersing resin varnish (solid content of 30%) containing tertiary-sulfonium groups was obtained by terminating tertiary conversion by adding 1595.2 parts of deionized water.

### Example 1

### Preparation of Mixture of Anti-Foaming Agent and Pigment Dispersing Resin

In a beaker, 100 g of an anti-foaming agent (Surfynol 124; acetylene diol anti-foaming agent, manufactured by Air Products and Chemicals, Inc.), the pigment dispersing resin varnish (solid content of 100 g) synthesized in Production Example 1 and pure water were weighed at an amount of a non-volatile content of 30% by weight and the mixture was stirred and dispersed by a disper to obtain a mixed additive in which the anti-foaming agent was kneaded with the dispersing resin.

Formulation to Electrodeposition Paint

Then, the above-mentioned mixed additive (equivalent to 6 g of the concentrate solution of anti-foaming agent) was added to 4 kg of an electrodeposition paint (POWERNICS 140 manufactured by Nippon Paint Co., Ltd.) preliminarily prepared, the mixture was stirred at 400 rpm for 1 hour by a magnetic stirrer to dissolve the anti-foaming agent in the paint. At this time, the anti-foaming agent was evaluated. Then, test panels were electrodeposition-coated with each of paint solutions and appearance (the presence or absence of generation of craters) was studied. Further, each of the paint solutions was filtered with a 500-mesh filter made of nylon and the presence of residue generated by aggregate was tested. The result of the evaluation is shown in Table 1.

Anti-Foaming Properties

Each of paint solutions was filled in a No. 4 Ford cup and a 1,000 ml measuring cylinder was placed under the hole of the Ford cup. Height from the hole of the Ford cup to the floor plane of the measuring cylinder was kept at 1 m, the paint solution was naturally dropped from the hole of the Ford cup and the volumes (ml) of foams just after dropping and after the lapse of fixed time were measured.

### Evaluation of Craters

The evaluation of craters was visually carried out according to the basis below.

### A—0

### B—1 to 5

C—6 or more

### Generation of Aggregates

The generation of aggregates was carried out according to the basis below.

### A—0 to 20 mg

### B—21 to 100 mg

C—101 mg or more

### Comparative Example 1

To 4 kg of electrodeposition paint (POWERNICS 140, manufactured by Nippon Paint Co., Ltd.) preliminarily prepared, 6 g of the concentrate solution of an anti-foaming agent was added by direct dropwise, the mixture was stirred at 400 rpm for 1 hour by a magnetic stirrer to dissolve the anti-foaming agent in the paint. for the same evaluation as in Example 1 was carried out. The result of the evaluation is shown in Table 1.

### Comparative Example 2

The anti-foaming agent solution was prepared by dissolving 100 g of the anti-foaming agent in 233.3 g of dipropylene glycol being a solvent and preparing non volatile content at 30% by weight.

The anti-foaming agent solution prepared by dissolving the anti-foaming agent in the solvent (corresponding to 6 g of the concentrate solution of anti-foaming agent) was added by direct dropwise addition to 4 kg of an electrodeposition paint (POWERNICS manufactured by Nippon Paint Co., Ltd.) preliminarily prepared, the mixture was stirred at 400 rpm for 1 hour by a magnetic stirrer to dissolve the anti-foaming agent in the paint. The same evaluation as in Examples was carried out. The result of the evaluation is shown in Table 1.

TABLE 1

| | Anti-foaming properties | | | Amount of | |
|---|---|---|---|---|---|
| | (unit: ml) | | | generating | Generation of |
| | Just after | 1 min | 5 min | craters | aggregates |
| Example | 140 | 40 | 15 | A | A |
| Comparative | 160 | 120 | 40 | C | A |
| Example 1 | | | | | |
| Comparative | 140 | 60 | 30 | B | B |
| Example 2 | | | | | |

As cleared from the result of the above-mentioned Table 1, the additive dispersing the anti-foaming agent with the pigment dispersing resin by mixing as shown by the present invention is superior in all points of the anti-foaming properties, the generation properties of craters and the generation of aggregates. On the other hand, in Comparative Example 1 in which the anti-foaming agent was added by a concentrate solution, evaluation is considerably bad in the anti-foaming properties and the generation properties of craters. Further, in Comparative Example 2 in which the anti-foaming agent was added in the form of mixing the anti-foaming agent in an organic solvent in the same manner as in a conventional example, the anti-foaming properties and the generation properties of craters were slightly improved than Comparative Example 1 but the generation of a lot of aggregates is observed.

What is claimed is:

1. A method for adding an anti-foaming agent into a cationic electrodeposition paint, wherein, when adding the anti-foaming agent to a cationic electrodeposition paint, a dispersion obtained by preliminarily dispersing the anti-foaming agent into a pigment dispersing resin for a cation electrodeposition paint in an amount of 5 to 1,000 parts by weight (solid content) based on 100 parts by weight (solid content) of a pigment dispersing resin is added to the cationic electrodeposition paint.

2. The method for adding an anti-foaming agent according to claim 1, wherein the cationic electrodeposition paint comprises a cationic epoxy resin, a curing agent and a pigment and the pigment is mixed in a form of a pigment paste in which the pigment is preliminarily dispersed with the pigment dispersing resin for the cationic electrodeposition paint.

3. The method for adding an anti-foaming agent according to claim 2, wherein the pigment is mixed with a pigment dispersing resin for the cationic electrodeposition paint to form an additive and then the additive is mixed with the cationic electrodeposition paint.

4. The method for adding an anti-foaming agent according to anyone of claim 3, wherein the anti-foaming agent is a nonionic type or acetylene diol type.

5. An antifoaming additive of a cationic electrodeposition paint which comprises the anti-foaming agent and the pigment dispersing resin for the cationic electrodeposition paint.

6. The antifoaming additive according to claim 5, wherein the anti-foaming agent is preliminarily dispersed in the pigment dispersing resin for the cationic electrodeposition paint.

7. The antifoaming additive according to claim 6, wherein the anti-foaming agent is a nonionic type or acetylene diol type.

8. A method of increasing the anti-foaming properties of an anti-foaming agent, wherein, when adding the anti-foaming agent into a cationic electrodeposition paint, the anti-foaming agent is preliminarily dispersed in a pigment dispersing resin for a cation electrodeposition paint in an amount of 5 to 1,000 parts by weight (solid content) based on 100 parts by weight (solid content) of the pigment dispersing resin and then added to the cationic electrodeposition paint.

9. A method for preventing bad influence by an anti-foaming agent in a cationic electrodeposition paint wherein, when adding the anti-foaming agent to a cationic electrodeposition paint, the anti-foaming agent is preliminarily dispersed in a pigment dispersing resin for a cation electrodeposition paint in an amount of 5 to 1,000 parts by weight (solid content) based on 100 parts by weight (solid content) of the pigment dispersing resin and then added to the cationic electrodeposition paint.
